(19) United States
(12) Patent Application Publication
(10) Pub. No.: US 2025/0112501 A1
(43) Pub. Date: Apr. 3, 2025

(54) COMMUNICATION MODULATIONS FOR WIRELESS POWER TRANSFER

(71) Applicant: Apple Inc., Cupertino, CA (US)

(72) Inventors: Alireza Safaee, San Jose, CA (US); Sriram Narayanan, Los Gatos, CA (US); Srinath Hosur, Fremont, CA (US); Xing Zhou, San Jose, CA (US)

(21) Appl. No.: 18/818,861

(22) Filed: Aug. 29, 2024

Related U.S. Application Data
(63) Continuation of application No. 18/746,744, filed on Jun. 18, 2024.
(60) Provisional application No. 63/586,454, filed on Sep. 29, 2023.

(51) Int. Cl. H02J 50/12; H04L 27/04

(52) U.S. Cl. CPC H02J 50/12; H04L 27/04

(57) ABSTRACT

A wireless power receiver can include a wireless power transfer coil; a rectifier that receives an AC voltage induced in the wireless power transfer coil by a wireless power transmitter and generates a DC output voltage therefrom; load modulation circuitry; and control circuitry that operates the rectifier to power a load coupled thereto and operates the load modulation circuitry to communicate with the wireless power transmitter by selectively altering power drawn from the wireless power transfer coil in accordance with an amplitude shift keying modulation scheme having a plurality of modulation depths.

### CROSS REFERENCE TO RELATED APPLICATIONS

This patent application claims priority to co-pending U.S. Provisional Patent Application 63/586,454, entitled “Communication Modulations for Wireless Power Transfer,” filed Sep. 29, 2023, and co-pending U.S. patent application Ser. No. 18/746,744, entitled “Communication Modulations for Wireless Power Transfer,” filed Jun. 18, 2024, which are hereby incorporated by reference.

### BACKGROUND

Load modulation can be used for in-band communication from a wireless power receiver (PRx) to a wireless power transmitter (PTx) using amplitude shift keying (ASK). Load modulator circuitry uses some power in the PRx to achieve ASK communication. This usage increases at relatively higher power levels.

### SUMMARY

Thus, it may be desirable to provide improved load modulation circuits systems and methods to improve communication reliability and operating efficiency for wireless power transfer systems.

A wireless power receiver can include: a wireless power transfer coil; a rectifier that receives an AC voltage induced in the wireless power transfer coil by a wireless power transmitter and generates a DC output voltage therefrom; load modulation circuitry; and control circuitry that operates the rectifier to power a load coupled thereto and operates the load modulation circuitry to communicate with the wireless power transmitter by selectively altering power drawn from the wireless power transfer coil in accordance with an amplitude shift keying modulation scheme employing differential Manchester encoding. The modulation scheme employed by the control circuitry can further include initially employing a first modulation depth to first and second symbols communicated to the wireless power transmitter; responsive to a communication failure, increasing a modulation depth associated with the first symbols to a higher modulation depth while maintaining a first modulation depth for the second symbols. Increasing a modulation depth associated with the first symbols to a higher modulation depth while maintaining a first modulation depth for the second symbols can reduce power consumption associated with the modulation scheme.

The modulation scheme employed by the control circuitry can further include, responsive to a further communication failure, increasing a modulation depth associated with the second symbols to a higher modulation depth. The first symbols can be one bits, and the second symbols can be zero bits. The first symbols can be zero bits, and the second symbols can be one bits. The load modulation circuitry can include a controllable current source coupled to a DC side of the rectifier, and the higher modulation depth can correspond to a higher current drawn by the controllable current source. The load modulation circuitry can include one or more controllable capacitances connected to an AC side of the rectifier.

A method of communicating data from a wireless power receiver to a wireless power transmitter via load modulation can be performed by control circuitry of the wireless power receiver operating load modulation circuitry of the wireless power receiver by: initially employing a first modulation depth to first and second symbols communicated to the wireless power transmitter; responsive to a communication failure, increasing a modulation depth associated with the first symbols to a higher modulation depth while maintaining a first modulation depth for the second symbols. The method can further include, responsive to a further communication failure, increasing a modulation depth associated with the second symbols to a higher modulation depth.

The first and second symbols communicated to the wireless power transmitter can be encoded with a differential Manchester encoding scheme in which the first symbols are one bits and the second symbols are zero bits. Increasing a modulation depth associated with the first symbols to a higher modulation depth while maintaining a first modulation depth for the second symbols can reduces power consumption associated with the modulation scheme. The load modulation circuitry includes a controllable current source coupled to a DC side of a rectifier of the wireless power receiver, and the higher modulation depth corresponds to a higher current drawn by the controllable current source. The load modulation circuitry can include one or more controllable capacitances connected to an AC side of a rectifier of the wireless power receiver.

A wireless power receiver can include: a wireless power transfer coil; a rectifier that receives an AC voltage induced in the wireless power transfer coil by a wireless power transmitter and generates a DC output voltage therefrom; load modulation circuitry; and control circuitry that operates the rectifier to power a load coupled thereto and operates the load modulation circuitry to communicate with the wireless power transmitter by selectively altering power drawn from the wireless power transfer coil in accordance with a modulation scheme. The modulation scheme employed by the control circuitry can further include: initially employing a first modulation depth to first and second symbols communicated to the wireless power transmitter; responsive to a communication failure, increasing a modulation depth associated with the first symbols to a higher modulation depth while maintaining a first modulation depth for the second symbols. The modulation scheme employed by the control circuitry can further include, responsive to a further communication failure, increasing a modulation depth associated with the second symbols to a higher modulation depth.

The first and second symbols communicated to the wireless power transmitter can be encoded with a differential Manchester encoding scheme in which the first symbols are one bits and the second symbols are zero bits. The first and second symbols communicated to the wireless power transmitter can be encoded with a differential Manchester encoding scheme in which the first symbols are zero bits and the second symbols are one bits.

Increasing a modulation depth associated with the first symbols to a higher modulation depth while maintaining a first modulation depth for the second symbols reduces power consumption associated with the modulation scheme.

The load modulation circuitry can include a controllable current source coupled to a DC side of the rectifier, and the higher modulation depth can correspond to a higher current drawn by the controllable current source. The load modulation circuitry can include one or more controllable capacitances connected to an AC side of the rectifier. The one or more controllable capacitances includes at least one communication capacitor selectively couplable to ground by a communication switch. The one or more controllable capacitances can include: a capacitor bank including a first communication capacitor and one or more additional communication capacitors selectively couplable in parallel with the first communication capacitor by one or more switches corresponding to the one or more additional communication capacitors; and a communication switch that selectively couples the first communication capacitors and any selectively paralleled communication capacitors to ground. The one or more controllable capacitances can include at least one communication capacitor selectively couplable to ground by one or more of a plurality of communication switches selectively operable in parallel.

A wireless power receiver can include a wireless power transfer coil; a rectifier that receives an AC voltage induced in the wireless power transfer coil by a wireless power transmitter and generates a DC output voltage therefrom; load modulation circuitry; and control circuitry that operates the rectifier to power a load coupled thereto and operates the load modulation circuitry to communicate with the wireless power transmitter by selectively altering power drawn from the wireless power transfer coil in accordance with an amplitude shift keying modulation scheme having a plurality of modulation depths.

The amplitude shift keying modulation scheme can include initially employing an initial modulation depth to symbols communicated to the wireless power transmitter; and responsive to a communication failure, increasing a modulation depth associated with the symbols, thereby improving communication reliability. Increasing the modulation depth associated with the symbols can include incrementally increasing the modulation depth responsive to a plurality of communication failures. The amplitude shift keying modulation scheme can further include responsive to an absence of communication failure, decreasing the modulation depth associated with the symbols, thereby improving operating efficiency. Decreasing the modulation depth associated with the symbols can include incrementally decreasing the modulation depth responsive to a plurality of absences of communication failures.

An absence of communication failure can be determined with reference to at least one of a missed response counter and a modulation timer. A communication failure can be determined with reference to a series of missed responses indicated by a counter. The plurality of modulation depths can be selectively applied to symbols more susceptible to channel interference.

The load modulation circuitry can include a controllable current source coupled to a DC side of the rectifier, and the higher modulation depth can correspond to a higher current drawn by the controllable current source. The load modulation circuitry can include one or more controllable capacitances connected to an AC side of the rectifier.

A method of communicating data from a wireless power receiver to a wireless power transmitter via load modulation can be performed by control circuitry of the wireless power receiver operating load modulation circuitry of the wireless power receiver by initially employing a first modulation depth to symbols communicated to the wireless power transmitter; responsive to a communication failure, increasing a modulation depth associated with the symbols, thereby improving communication reliability; and responsive to an absence of communication failure, decreasing the modulation depth associated with the symbols, thereby improving operating efficiency.

Increasing the modulation depth associated with the symbols can include incrementally increasing the modulation depth responsive to a plurality of communication failures. Decreasing the modulation depth associated with the symbols can include incrementally decreasing the modulation depth responsive to a plurality of absences of communication failures. An absence of communication failure can be determined with reference to at least one of a missed response counter and a modulation timer. A communication failure can be determined with reference to a series of missed responses indicated by a counter. The increased modulation depths can be selectively applied to symbols more susceptible to channel interference.

A wireless power receiver can include a wireless power transfer coil; a rectifier that receives an AC voltage induced in the wireless power transfer coil by a wireless power transmitter and generates a DC output voltage therefrom; load modulation circuitry; and control circuitry that operates the rectifier to power a load coupled thereto and operates the load modulation circuitry to communicate with the wireless power transmitter by selectively altering power drawn from the wireless power transfer coil in accordance with a modulation scheme. The modulation scheme employed by the control circuitry can further include initially employing a first modulation depth to symbols communicated to the wireless power transmitter; responsive to a communication failure, increasing a modulation depth associated with the symbols, thereby improving communication reliability; and responsive to an absence of communication failure, decreasing the modulation depth associated with the symbols, thereby improving operating efficiency.

The modulation scheme employed by the control circuitry can further include incrementally increasing the modulation depth responsive to a plurality of communication failures; and incrementally decreasing the modulation depth responsive to a plurality of absences of communication failures. The symbols communicated to the wireless power transmitter can be encoded with a differential Manchester encoding scheme. Increased modulation depths can be selectively applied to symbols more susceptible to channel interference.

The load modulation circuitry can include a controllable current source coupled to a DC side of the rectifier, and the higher modulation depth can correspond to a higher current drawn by the controllable current source. The load modulation circuitry can include one or more controllable capacitances connected to an AC side of the rectifier. The one or more controllable capacitances can include at least one communication capacitor selectively couplable to ground by a communication switch. The one or more controllable capacitances can include a capacitor bank including a first communication capacitor and one or more additional communication capacitors selectively couplable in parallel with the first communication capacitor by one or more switches corresponding to the one or more additional communication capacitors; and a communication switch that selectively couples the first communication capacitors and any selectively paralleled communication capacitors to ground. The one or more controllable capacitances can include at least one communication capacitor selectively couplable to ground by one or more of a plurality of communication switches selectively operable in parallel.

### BRIEF DESCRIPTION OF THE DRAWINGS

FIG. 1 illustrates a simplified block diagram of a wireless power transfer system.

FIG. 2 illustrates a schematic diagram of a wireless power receiver using AC side capacitive modulation for PRx to PTx communication.

FIG. 3 illustrates a schematic diagram of a wireless power receiver using DC side load modulation for PRx to PTx communication.

FIG. 4 illustrates illustrative bit sequences for a differential Manchester encoding scheme used for in-band communication in a wireless power transfer system.

FIG. 5 illustrates the use of different modulation bit depths to improve communication reliability for in-band communication in a wireless power transfer system.

FIG. 6 illustrates an improved use of different modulation bit depths to improve communication reliability and efficiency for in-band communication in a wireless power transfer system.

FIG. 7 illustrates a flowchart depicting selection of different modulation bit depths to improve communication reliability and efficiency for in-band communication in a wireless power transfer system.

FIGS. 8A-8B illustrate alternative configurations for capacitive modulation circuits for use in capacitive modulation for PRx to PTx communication.

FIG. 9 illustrates a control technique for controlling modulation depth in a wireless power transfer system.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

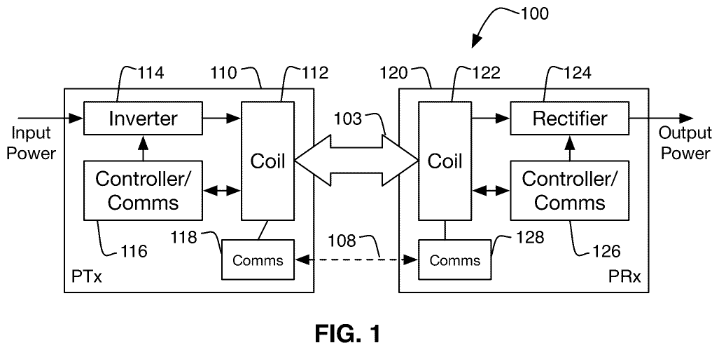

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 103. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module in the PRx via the power transfer coils. In other embodiments, comms module 118 may communicate with a corresponding module using a separate physical channel 108.

As noted above, wireless power transfer system also includes a wireless power receiver (PRx) 120. Wireless power receiver can include a receiver coil 122 that may be magnetically coupled 103 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module using a separate physical channel 108.

Numerous variations and enhancements of the above-described wireless power transmission system 100 are possible, and the following teachings are applicable to any of such variations and enhancements.

As described above, load modulation can be used to facilitate in-band communication in a wireless power transfer system. For example, receiver-side load modulation may be used to implement amplitude shift keying (ASK) communication from a PRx device to a PTx device. Described herein is an improved modulation scheme, based on having two or more separate modulation depths for 0 bits (zero bits) and 1 bits (one bits), to allow for improved communication performance with while also allowing for reduction of the energy used in the load modulator, thereby improving operating efficiency while preserving or improving communication reliability. This approach described herein can be robust, highly integrable (requiring no additional passive components), and low-cost. The reduced energy consumption can improve the user experience, for example in form of faster charge time by improving charging efficiency. Moreover, the improved modulation technique can be, in some embodiments, entirely implemented on the power receiver side (PRx), allowing incorporation of the present technology with Qi and/or proprietary wireless power transmitters (PTx) without PTx-side modifications. Qi is family of wireless power transfer standards promulgated by the Wireless Power Consortium.

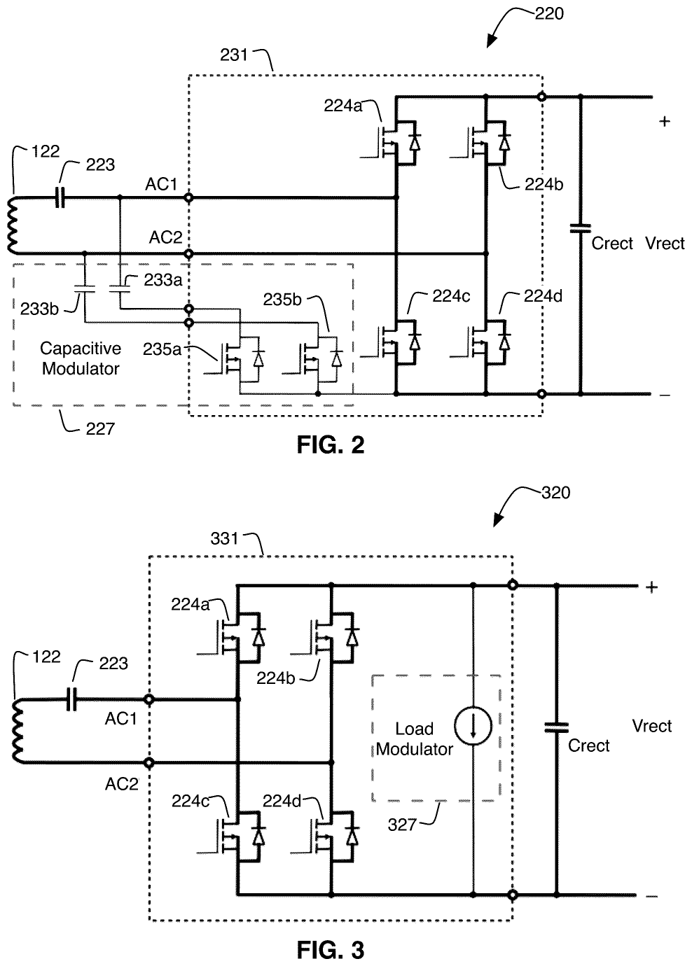

In wireless power transfer, in-band communication, i.e., modulating the power waveform to transfer information, may be used to allow for in-band communication, i.e., communication using the wireless power transfer itself as the communication channel. Amplitude shift keying (ASK) may be used for sending information from PRx to PTx. One industry standard for wireless power transfer, the Qi standard referenced above, describes two flavors of circuit structures for implementing ASK, namely AC-side modulation and DC-side modulation. AC-side modulation can be realized in different ways, e.g., by changing the AC impedance of the PRx circuit, or by careful manipulation of rectifier signals. An example implementation of AC-side modulation employing extra capacitors and switches is described below with reference to FIG. 2. DC-side modulation can employ a modulator that generates a data-dependent load current variation on the DC side of the PRx rectifier. A common realization uses a controlled current source as the modulator connected to rectifier DC lines. It can add momentary extra load to the PRx rectifier output. An exemplary embodiment is described below with reference to FIG. 3.

FIG. 2 illustrates a schematic diagram of a wireless power receiver (PRx) 220 using AC side capacitive modulation for PRx to PTx communication. Wireless power receiver 220 includes a receiver coil 122 as described above. Receiver coil 122 can be coupled to a rectifier circuit by a resonant capacitor 223. The illustrated exemplary rectifier circuit is depicted as a full bridge rectifier made up of switching devices 224a-224b, depicted as MOSFETs; however, other rectifier topologies and/or other rectifier switching device types could be used as appropriate for a given application. The output of the rectifier is a DC voltage Vrect that can appear across an output capacitor Crect and can be supplied to a load (not shown), such as a battery or other power system for an electronic device.

Wireless power receiver 220 can also include capacitive modulator circuitry 227. In the illustrated exemplary embodiment, this includes communication capacitors 223a and 223b connected to each AC leg of the receiver winding resonant circuit that can be selectively coupled to ground (e.g., the negative rail of the rectifier output) by switching devices 235a and 235b. As with the rectifier switches, these switching devices are depicted as MOSFETs; however, other switching device types could be used as appropriate for a given application. In any case, selectively coupling or decoupling these capacitors to the circuit can allow for a modulation of the AC impedance seen by the wireless power transmitter, thereby allowing communication from wireless power receiver 220 to a wireless power transmitter.

The switching devices of wireless power transmitter 220 can be (but need not be) integrated into a single integrated circuit 231, which can also include the controller and communication circuitry 126 as described above. The communication capacitors may be separate from this integrated circuit 231 (as depicted in FIG. 2), which can allow their values to be altered depending on the requirements of a particular system. Alternatively, the communication capacitors could also be part of the integrated circuit. AC-side capacitive modulation provides advantages such as increased bandwidth, and propagation of messages from PRx to PTx can happen quickly.

FIG. 3 illustrates a schematic diagram of a wireless power receiver (PRx) 320 using DC side load modulation for PRx to PTx communication. Wireless power receiver 320 includes a receiver coil 122 as described above. Receiver coil 122 can be coupled to a rectifier circuit by a resonant capacitor 223. The illustrated exemplary rectifier circuit is depicted as a full bridge rectifier made up of switching devices 224a-224b, depicted as MOSFETs; however, other rectifier topologies and/or other rectifier switching device types could be used as appropriate for a given application. The output of the rectifier is a DC voltage Vrect that can appear across an output capacitor Crect and can be supplied to a load (not shown), such as a battery or other power system for an electronic device.

Wireless power receiver 220 can also include load modulator circuitry 327. In the illustrated exemplary embodiment, this is depicted as a controllable current source that can add momentary extra load to the PRx rectifier output. Although described herein as a current “source,” the circuitry could also be considered as a current “sink” in that it increases current drawn from the rectifier, and thus ultimately the wireless power receiving coil and the PTx device. Although “current source” is used herein, this term should be understood as including a current sink. Other implementations for such circuits are known to those skilled in the art; thus details of such circuitry are omitted here for sake of brevity. The switching devices of wireless power transmitter 320, together with load modulator circuitry 327, can be (but need not be) integrated into a single integrated circuit 331, which can also include the controller and communication circuitry 126 as described above. Advantages of DC-side modulation may include reduction of passive components (e.g., AC-side communication capacitors)

When employing load modulation, various modulation and encoding schemes can be used. It may be desirable to have a load modulation scheme that can reduce power dissipation by ASK communications, so it can be applied in higher power designs, which may have simultaneously higher values of modulating current and Vrect. It may also be desirable to prevent Vrect from reducing, so power transfer capability of the PTx-PRx system is maintained. It may also be desirable to be able to implement such a scheme with a reduced number of passive components.

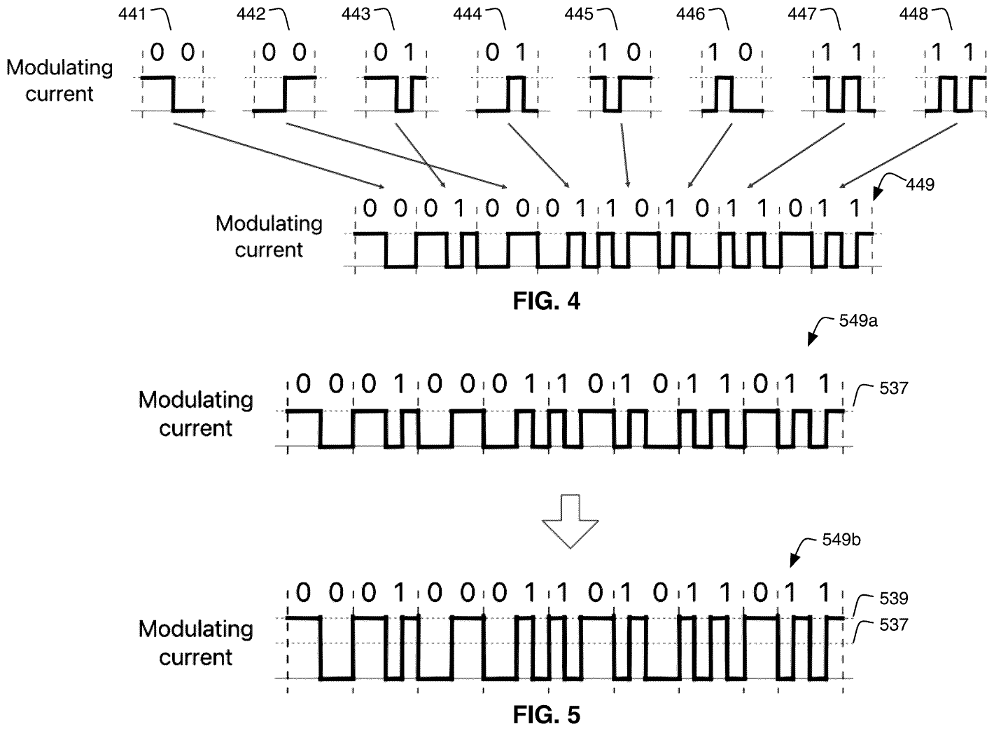

As described above, at least one industry standard employs amplitude shift keying (ASK), in which the amplitude of a signal is modulated to provide data communication. Such ASK schemes can employ different techniques for encoding data on amplitude-based modulation of the load signal, such as differential Manchester encoding. An exemplary form of differential Manchester encoding is depicted in FIG. 4. differential Manchester encoding uses a change in the amplitude of the modulating current in each bit period to represent a 1 or a zero. Thus, each bit period will have at least one modulating current (or voltage) transition during each bit period. The “guaranteed” transition can occur, for example, at the beginning of the bit period. In some encoding schemes, this can be used to encode a zero bit. Thus, for a one bit there will be a second transition during the bit period, as described further below.

FIG. 4 illustrates illustrative bit sequences for a differential Manchester encoding scheme used for in-band communication in a wireless power transfer system. The upper portion of FIG. 4 depicts eight possible bit pair encodings 441-448 for each possible two-bit sequence. Each bit pair encoding illustrates two bit periods, one for each bit. Which of the two possible encodings for each bit pair is used depends on the value of the preceding bit. Bit pair encoding 441 depicts one possible encoding for a zero bit followed by a zero bit (i.e., 00). Thus, there is a single transition from high to low between the two bit periods. Bit pair encoding 442 depicts an alternative possible encoding for a zero bit followed by a zero bit (i.e., 00). Thus, there is a single transition from low to high between the two bit periods. Similarly, bit pair encodings 443 and 444 depict a zero bit followed by a one bit (i.e., 01). These encodings include a single transition during (at the beginning) of the first bit period for the zero, with a second transition at the beginning of the second bit period, and a third transition in the middle of the second bit period corresponding to the one bit. Likewise, bit pair encodings 445 and 446 depict a one bit followed by a zero bit (i.e., 10). These encodings include a first transition at the beginning of the first bit period for the one, with a second transition also occurring during the first bit period, and a third transition at the beginning of the second bit period corresponding to the zero bit. Finally, bit pair encodings 447 and 448 depict a one bit followed by a one bit (i.e., 11). These encodings include a first transition at the beginning of the first bit period for the one, with a second transition also occurring during the first bit period, and a third transition at the beginning of the second bit period for the one, with a second transition also occurring during the second bit period. These eight possible bit pair encodings 441-448 are combined into a bitstream 449 indicating the possible transitions.

From the foregoing, it can be appreciated that a differential Manchester encoded ASK signal associated with one or more one bits can have a higher frequency content than a one or more zero bits. In other words, the zero bits can have only a single transition of the modulating current per bit period, while the one bits have two transitions per bit period. When using wireless power transfer circuitry as the communication channel, it can have different electrical behavior at the different frequencies associated with the one bits versus the zero bits. For example, an inductive power transfer system may act as a low pass filter, thereby attenuating the portions of the signal associated with the one bits. This may become more acute as the communication data rate, and thus effective frequency of the differential Manchester-encoded ASK signal, increases.

In case of unsuccessful ASK communication, one mitigation approach can be to increase the amplitude of the modulating current as shown in FIG. 5, which illustrates the use of different modulation bit depths to improve communication reliability for in-band communication in a wireless power transfer system. This single level of modulating current can be called the modulation depth, and the scheme depicted in FIG. 5 can be called a one-tier modulation depth approach, because only a single level of modulating current is used. Thus, a bitstream 549a (which corresponds to bitstream 449 discussed above with reference to FIG. 4) can be modulated using a first, lower modulating current level 537. In the event of unsuccessful communication, for example because the PTx cannot successfully detect and/or decode the load modulation for any of a variety of reasons, the modulation bit depth can be increased, as depicted in the lower portion of FIG. 5. More specifically, bitstream 459b (also corresponding to bitstream 449 discussed above) can be modulated with an increased modulation depth 539 that is higher than the initial modulating depth 537. In other words, a higher current value is used, which imposes larger load changes that can presumptively be more easily detected and decoded by the receiving device (e.g., a PTx device). In some embodiments, the modulating current can have multiple bit depths corresponding to different modulating currents. As one example, the modulation depths could be between 30 mA and 140 mA in 20 mA steps, although other minimum, maximum, and step values could also be used.

In FIG. 5, it can be seen that for all the zero bits where the modulating current is non-zero, the duration of current flow is double the time of current flow for one bits. This means that the energy dissipation associated with zero bits (with the non-zero modulating current) can be roughly double the energy dissipation associated with one bits. To reduce the energy consumption of the in-band communication while mitigating potential impact on the robustness of the ASK modulation and differential Manchester encoding scheme, an improved technique may be desired. Such a solution could, in at least some applications, provide similar values of AVrect for zero bits and one bits for desirable communications, and may provide a ratio of energy dissipation closer to unity for zero bits (with the non-zero modulating current) to one bits.

Investigations by the inventors have revealed that at operating points with unfavorable conditions ASK packet failures frequently first occur in one bits, although an ASK communications failure can result from a failure to properly receive one or more one bits or one or more zero bits. This is believed to originate from the lower amplitude of one bits, relative to zero bits, due to the higher frequency content of one bits and the low pass nature of the channel. Thus, the one bits are believed to be more impacted by the nature of the wireless power path.

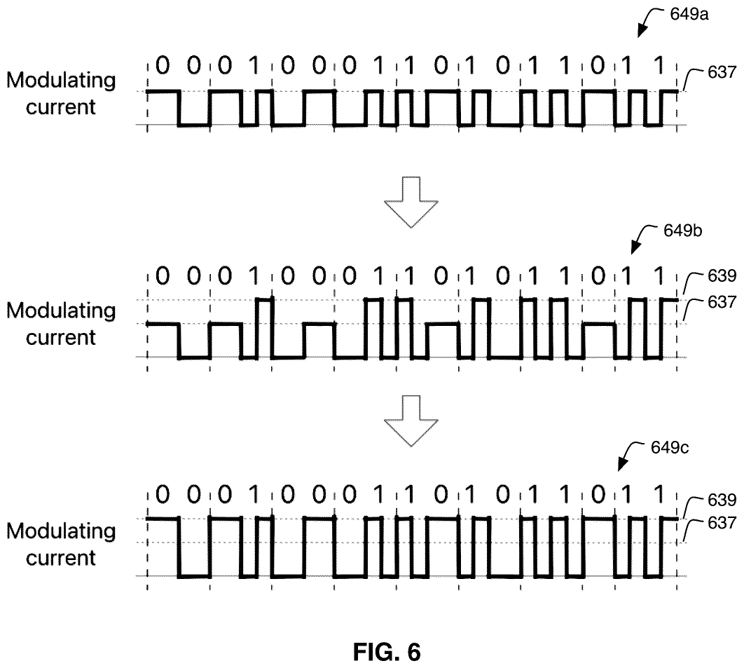

FIG. 6 illustrates an improved use of different modulation bit depths (e.g., a two-tier modulation) to improve communication reliability and efficiency for in-band communication in a wireless power transfer system. More specifically, the arrangement illustrated in FIG. 6 can enhance the more failure-prone one bits without unnecessarily increasing energy consumption associated with the zero bits. Such a solution can be provided by using two separate modulations depths, a first for zero bits and another for one bits, instead of a single level (one-tier) modulation depth that is uniformly increased for both one bits and zero bits (as described above with reference to FIG. 5). In the example of a wireless power receiver (PRx) communicating with a wireless power transmitter (PTx), the PRx can initially apply a minimum value of modulation depths for both zero bits and one bits to establish the ASK communications with the minimum energy consumption, shown in the top plot in FIG. 6. Thus, a bitstream 649a can be modulated with a first modulation depth 637. In case of unsuccessful communication, an initial response can include increasing the modulations depth for one bits without increasing the modulation depth for zero bits, as shown in the middle plot in FIG. 6. In other words, zero bits of bitstream 649b can continue to be modulated using the initial modulation depth 637, while one bits can be modulated with a second modulation depth 639 that is higher (e.g., corresponds to a higher current) than the first modulation depth 637. This can reduce the energy used by zero bits. Should there be continued communication failures, the modulation depth for zero bits can also be increase, as depicted in the lower plot in FIG. 6, in which bitstream 649c has both zero bits and one bits modulated with the second modulation depth 639 that is greater than first modulation depth 637.

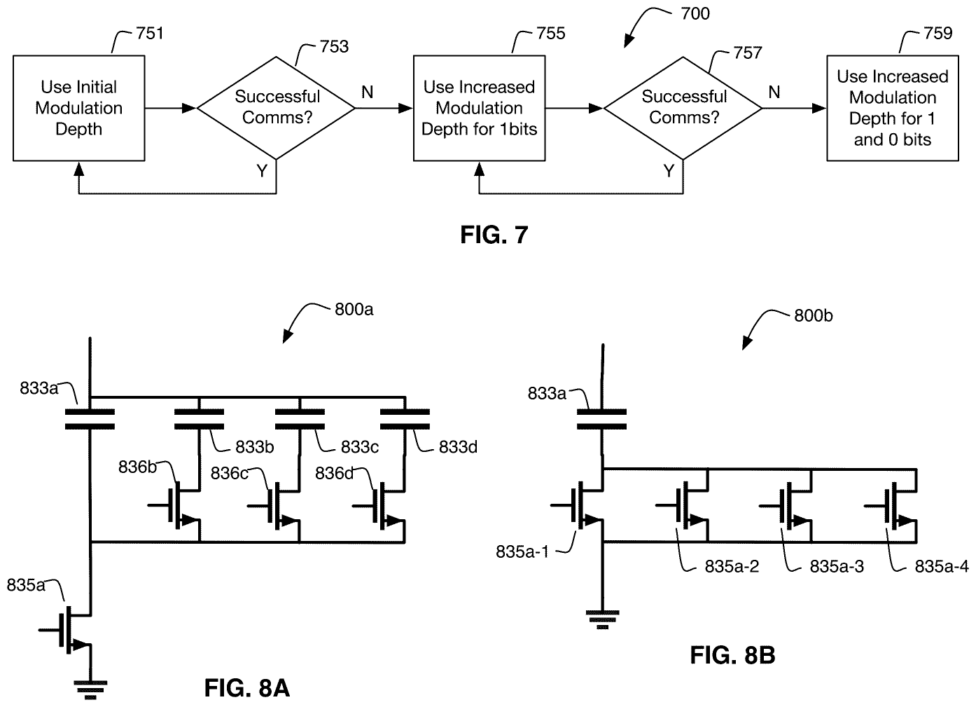

FIG. 7 illustrates a flowchart 700 depicting selection of different modulation bit depths as described above with reference to FIG. 6 to improve communication reliability and efficiency for in-band communication in a wireless power transfer system. Such a method may be formed by a controller of the communication transmitting device, which may be a wireless power receiver as described above. Thus, the method depicted in FIG. 7 can be performed, for example, by controller and communication circuitry 126 described above. Other implementations are also possible, in which the method can be performed by other suitable processing or control circuitry in various types of devices. Beginning with block 751, the controller can use an initial modulation depth, e.g., modulation depth 637 depicted in FIG. 6 and described above. Then, in block 753, the controller can determine whether communication is successful. This can be determined in various ways, including the receipt of a communication failure indication from the communication receiving device (e.g., a wireless power transmitter/PTx device). Such a communication failure indication can either be an explicit message received from the counterpart device or may be an inference drawn from the behavior of the counterpart device, such as the absence of an expected acknowledgement.

If, in block 753, the controller determines that communication has been successful, it can continue to use the initial modulation depth (block 751). Alternatively, if, in block 753, the controller determines that communication has not been successful, it can use an increased modulation depth for one bits (block 755), as described above. It should be noted that in other modulation schemes, the increased modulation depth could be used for other bits. As one example, if one bits were encoded using a single transition per bit period and zero bits were encoded using two transitions per bit period, the increased modulation depth could be more properly used with the zero bits. Thus, a more general statement of the solution could be to use an increased modulation depth for symbols that are more susceptible to disruption by communication channel conditions while maintaining use of an initial modulation depth for symbols that are less susceptible to such disruption.

In any case, in block 757, the controller can determine whether communication is successful using this first modulation tier in which an increased modulation depth is used only for certain symbols, e.g., one bits. If communication at this first tier is successful, the controller can continue to use this modulation configuration (block 755). Alternatively, if, in block 757, the controller determines that communication has not been successful, it can use an increased modulation depth for all bits (block 759), as described above. Thus, a more general statement of the solution could be to use an increased modulation depth for symbols that are more susceptible to disruption by communication channel conditions while maintaining use of an initial modulation depth for symbols that are less susceptible to such disruption.

The modulation scheme can be further extended based on what has been described herein. For example, additional modulation bit depths can be provided, which can further increase detectability and decodability of the ASK signal. As with the examples described above, the increase to these still higher modulation depths can be made stepwise, being initially applied to symbols that are more susceptible to channel degradation and only subsequently applied to all symbols if the initial adjustment is not able to ensure successful communication. Alternatively, the stepwise increase in modulation depths could be applied to all symbols simultaneously.

The multi-tier modulation schemes described above selectively employing increased modulation depth for one or more transmitted symbols have been described in the context of wireless power transmitters employing DC-side load modulation as described above with respect to FIG. 3. More specifically, such schemes have been described in the context of increased load current being drawn by a current source associated with such schemes to increase the modulation depth. However, the modulation schemes described herein need not be limited to DC side increases in current to increase modulation depth. Various techniques can be employed on both the DC side or AC side to provide a transmitted power modulation that can be detected and decoded by a wireless power transmitting (communications receiving) device. This modulation can be of a voltage, current, complex impedance phase angle, real power level, reactive power level, etc. As one example, the modulation technique can be extended to capacitive modulation circuits employed on the AC side, as described above with respect to FIG. 2. Such systems can selectively alter reactive circuit parameters with differing modulation depths to similar effect. FIGS. 8A-8B illustrate alternative configurations for capacitive modulation circuits for use in such implementations.

FIG. 8A illustrates an exemplary capacitive modulation circuit 800a, examples of which can be used on each leg of the PRx AC side as described above with respect to FIG. 2. Switch 835a can be the communication switch, and the communication capacitance can be altered to change the modulation depth. Thus, a single communication capacitor 833a can be used in some circumstances. One or more additional communication capacitors 833b-833d can be selectively coupled in parallel with communication capacitor 833a by corresponding switches 836b-836d. This can allow for differing modulation depths as described above.

FIG. 8B illustrates an alternative exemplary capacitive modulation circuit 800b, examples of which can be used on each leg of the PRx AC side as described above with respect to FIG. 2. Switch 835a-1 can be the communication switch, and capacitor 833a can be the communication capacitor. Additional switches 835a-2-835a-4 can be connected in parallel with communication switch 835a-1 and selectively operated in tandem therewith to present a different resistance in the circuit. This differing resistance, associated with paralleling of the Rdson resistances of the respective switches can be used to alter the properties of the capacitance modulation circuit and thus provide differing modulation depths as described herein.

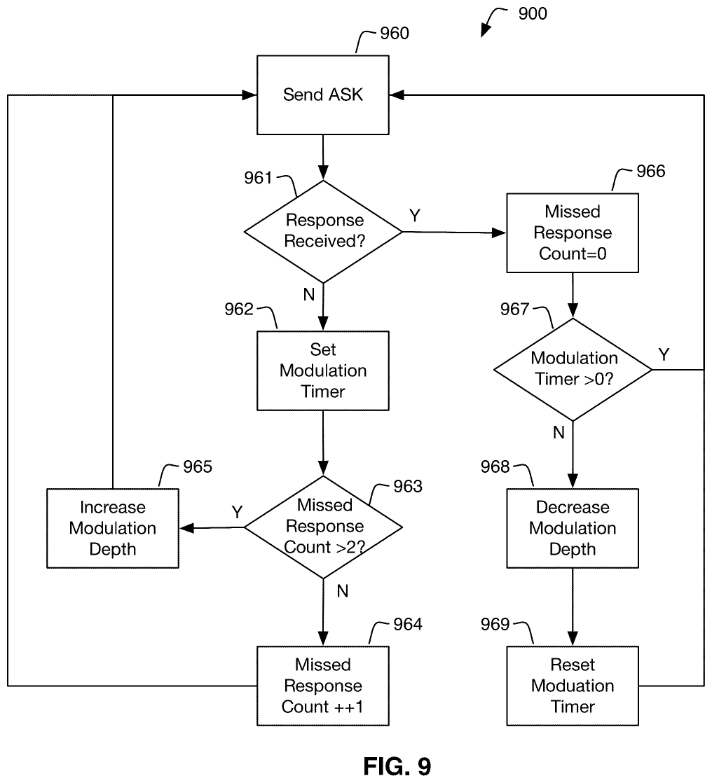

FIG. 9 illustrates a flow chart 900 of a control technique for controlling multi-tier modulation depth in a wireless power transfer system. The control technique can be applied to multi-tier modulation depth systems as described above. This can include, but need not be limited to, modulation schemes in which different modulation depths are applied to some symbols (e.g., symbols more susceptible to channel interference) versus other symbols (e.g., symbols less susceptible to channel interference). This can include, but need not be limited to, Manchester encoding schemes as described above. Moreover, the control technique of FIG. 9 can be applied to multi-tier modulation schemes in which the same modulation depth is applied to all symbols.

With further reference to FIG. 9, the control technique 900 can be performed by a wireless power receiver, e.g., by control/communication circuitry of the wireless power receiver as described above. Beginning with block 960, the wireless power receiver can send a communication, e.g., an ASK communication, to a wireless power transmitter. The wireless power transmitter can be expected to respond, e.g., with an FSK message. In some embodiments, this could be a CE (control error) or XCE (extended control error) packet in accordance with a version of the Qi standards promulgated by the Wireless Power Consortium, potentially including extension to such standards, which may include public extension and/or proprietary extensions. In other cases, other types of communications from the wireless power transmitter in response to the ASK communication from the wireless power receiver could be used. In any case, in block 961, the wireless power receiver can determine whether a response to the ASK communication of block 960 was received. If not, the wireless power receiver can set a modulation timer in block 962. This modulation timer is discussed in greater detail below with reference to blocks 967 and 969.

Thereafter, the wireless power receiver can determine whether the missed response count (discussed further below) is greater than 2, i.e., there have two or fewer expected communications from the wireless power transmitter have been missed. If not, i.e., two or fewer expected responses from the wireless power transmitter have been missed, then the wireless power receiver can increment the missed response counter (block 964) and send another ASK communication (block 960), at which point the flow can repeat. Otherwise, if in block 963 the missed response count is greater than 2, meaning that more than two expected responses from the wireless power transmitter have been missed, then the wireless power receiver can increase the modulation depth (block 965). As described above, this can include increasing the modulation depth for only certain symbols more susceptible to channel interference or can include increasing the modulation depth for all symbols. Additionally, increasing the modulation depth can increasing the modulation depth by one step in a plurality of available modulation depths. In any case, the receiver can thereafter send another ASK communication message (block 960) using the increased modulation depth, with the flow repeating.

After sending an ASK communication in block 960, if the wireless power receiver determines in block 961 that a wireless power response was received, then the wireless power receiver can reset the missed response counter to zero in block 966. Incrementing the missed response counter was discussed above with reference to block 964. The wireless power receiver can then check in block 967, whether the modulation timer (set in block 962 as discussed above) is greater than zero (i.e., has not expired). If so, then the wireless power receiver can send further ASK communications (block 960) with the current modulation depth. Otherwise, if the modulation timer has expired, indicating that the present modulation depth has been used for a sufficient period of time that the wireless power receiver can decrease the modulation depth (block 968) and reset the modulation timer (block 969). The modulation timer can be initially set to a value corresponding to a time period over which communication can be considered stably successful if no expected responses are not received over that interval. In some embodiments, the timer could be initially set (in block 962) and reset (in block 969) to 1500 ms, although other values could also be used.

To summarize the above operations described with respect to FIG. 9, a wireless power receiver (for example using its controller/communication circuitry) can transmit communication packets, e.g., ASK communication packets to a wireless power receiver. If an expected response (e.g., an FSK communication packet) is not received from a wireless power transmitter, then a timer can be set and a counter incremented. If a consecutive number of expected responses are not received, then the modulation depth can be increased. In some embodiments, the consecutive number of missed expected responses can be three (i.e., greater than 2), although other thresholds could also be used. Increasing the modulation depth can be stepwise, as described above, meaning that a plurality of incremental increases in modulation depth can be applied in response to repeated sequences of multiple missed expected communications. Additionally or alternatively, the increase in modulation depth can be selectively applied to certain symbols that are more susceptible to channel interference and not applied to other symbols to improve operating efficiency, as was described above. In some cases, the successive incremental increases in modulation depth could include increasing modulation depth for certain symbols more susceptible to channel interference in response to a first sequence of missed expected communication, and thereafter increasing the modulation depth for all symbols to the same level in response to a second sequence of missed expected communications, with the alternating/selective application further continuing in response to continued communication failures.

In some instances, the number of missed communications triggering an increase in modulation depth can be correlated with the modulation timer. In other words, if responses are expected at an interval such as 250 ms, then the count of such packets (e.g., 3) could correspond to one-half the modulation timer, e.g., 750 ms. In other cases, the count could correspond to the modulation timer, a multiple of the modulation timer (e.g., 2×, 3×, etc.) or a fraction of the modulation timer (e.g., x/2, x/3, etc.).

Continuing the summary of the operation mode described with reference to FIG. 9, if an expected response (e.g., an FSK communication packet) is received from a wireless power transmitter, the missed response counter can be reset. If the modulation timer has expired, which in conjunction with a number of consecutive received expected responses indicates successful communication condition, then the modulation depth can be decreased and the modulation timer reset. Otherwise, if the timer has not yet expired this can be an indication that channel conditions appear adequate, but more time is needed to verify that a lower modulation depth can be attempted. As described in the preceding paragraph, the missed response counter and timer values may be correlated so that the timer corresponds to a selected number of successfully received packets. As with modulation depth increases, decreasing the modulation depth can also be stepwise, as described above, meaning that a plurality of incremental decreases in modulation depth can be applied in response to repeated sequences of multiple received expected communications over a selected time interval. Additionally or alternatively, the decreases in modulation depth can be selectively applied to certain symbols that are less susceptible to channel interference and not applied to other symbols more susceptible to channel interference to improve operating efficiency, as was described above. In some cases, the successive incremental decreases in modulation depth could include decreasing modulation depth for certain symbols less susceptible to channel interference in response to a first sequence of received expected communications, and thereafter decreasing the modulation depth for all symbols to the same level in response to a second sequence of received expected communications, with the alternating/selective application further continuing in response to continued communication successes.

Depending on various implementation details, an improved multi-tier modulation scheme for in-band communication in a wireless power transfer system as described herein can enjoy a number of advantages. For example, such a system can have a reduction in energy dissipation in the load modulator by reducing the energy used for zero bits versus one bits. Lower power dissipation in can allow for smaller integrated circuit silicon area, increased operating efficiency, easier PCB design, and potentially higher reliability. Such advantages may be particularly beneficial in certain types of wireless power receiver devices, such as smartphones, smartwatches, other wearables, etc. An additional potential advantage can include a lower reduction in Vrect for zero bits during ASK communications, which can increase the wireless power transfer capability, allowing for shorter charging times in at least some applications.

Such multi-tier modulation and encoding schemes may also be used with higher data rate communications without requiring further modification or adaptation. Likewise, it can be used with any of a wide variety of higher switching frequencies that may be associated with improved industry standard wireless power transfer techniques and/or various proprietary wireless power transfer techniques. In the case of some PRx configurations, e.g., those described above with respect to FIGS. 2 and 3, no extra passive components are required, nor or any extra connection terminals for the receiver integrated circuit (if such a device is provided in such integrated circuit form). This can result in a highly integrable design in which ratings of the power circuit components are not impacted.

Additionally, such multi-tier modulation schemes need not be particularly sensitive to the component tolerances. Moreover, such modulation techniques can be completely transparent to PTx side (i.e., the communication receiving device). Therefore, an PRx using this approach can be compatible with any existing wireless power transmitter with which it would otherwise be compatible. In at least some cases, use of such multi-tier modulation schemes can expand the range of operable PTx-PRx misalignment, as it can increase the Vrect voltage allowing the system to operate further from any under-voltage brown out limit.

Described above are various features and embodiments relating to modulation bit depth adjustment for in-band communication in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communication between inductively coupled devices are spoofed.

1. A wireless power receiver comprising:
a wireless power transfer coil;
a rectifier that receives an AC voltage induced in the wireless power transfer coil by a wireless power transmitter and generates a DC output voltage therefrom;
load modulation circuitry; and
control circuitry that operates the rectifier to power a load coupled thereto and operates the load modulation circuitry to communicate with the wireless power transmitter by selectively altering power drawn from the wireless power transfer coil in accordance with an amplitude shift keying modulation scheme having a plurality of modulation depths.

2. The wireless power receiver of claim 1 wherein the amplitude shift keying modulation scheme comprises:
initially employing an initial modulation depth to symbols communicated to the wireless power transmitter; and
responsive to a communication failure, increasing a modulation depth associated with the symbols, thereby improving communication reliability.

3. The wireless power receiver of claim 2 wherein increasing the modulation depth associated with the symbols comprises incrementally increasing the modulation depth responsive to a plurality of communication failures.

4. The wireless power receiver of claim 3 wherein the amplitude shift keying modulation scheme further comprises:
responsive to an absence of communication failure, decreasing the modulation depth associated with the symbols, thereby improving operating efficiency.

5. The wireless power receiver of claim 4 wherein decreasing the modulation depth associated with the symbols comprises incrementally decreasing the modulation depth responsive to a plurality of absences of communication failures.

6. The wireless power receiver of claim 4 wherein an absence of communication failure is determined with reference to at least one of a missed response counter and a modulation timer.

7. The wireless power receiver of claim 2 wherein a communication failure is determined with reference to a series of missed responses indicated by a counter.

8. The wireless power receiver of claim 1 wherein the plurality of modulation depths are selectively applied to symbols more susceptible to channel interference.

9. The wireless power receiver of claim 1 wherein the load modulation circuitry includes a controllable current source coupled to a DC side of the rectifier, and the higher modulation depth corresponds to a higher current drawn by the controllable current source.

10. The wireless power receiver of claim 1 wherein the load modulation circuitry includes one or more controllable capacitances connected to an AC side of the rectifier.

11. A method of communicating data from a wireless power receiver to a wireless power transmitter via load modulation, the method being performed by control circuitry of the wireless power receiver operating load modulation circuitry of the wireless power receiver by:
initially employing a first modulation depth to symbols communicated to the wireless power transmitter;
responsive to a communication failure, increasing a modulation depth associated with the symbols, thereby improving communication reliability; and
responsive to an absence of communication failure, decreasing the modulation depth associated with the symbols, thereby improving operating efficiency.

12. The method of claim 11 wherein increasing the modulation depth associated with the symbols comprises incrementally increasing the modulation depth responsive to a plurality of communication failures.

13. The method of claim 11 wherein decreasing the modulation depth associated with the symbols comprises incrementally decreasing the modulation depth responsive to a plurality of absences of communication failures.

14. The method of claim 11 wherein an absence of communication failure is determined with reference to at least one of a missed response counter and a modulation timer.

15. The method of claim 11 wherein a communication failure is determined with reference to a series of missed responses indicated by a counter.

16. The method of claim 11 wherein increased modulation depths are selectively applied to symbols more susceptible to channel interference.

17. A wireless power receiver comprising:
a wireless power transfer coil;
a rectifier that receives an AC voltage induced in the wireless power transfer coil by a wireless power transmitter and generates a DC output voltage therefrom;
load modulation circuitry; and
control circuitry that operates the rectifier to power a load coupled thereto and operates the load modulation circuitry to communicate with the wireless power transmitter by selectively altering power drawn from the wireless power transfer coil in accordance with a modulation scheme, the modulation scheme employed by the control circuitry further comprising:
initially employing a first modulation depth to symbols communicated to the wireless power transmitter;
responsive to a communication failure, increasing a modulation depth associated with the symbols, thereby improving communication reliability; and
responsive to an absence of communication failure, decreasing the modulation depth associated with the symbols, thereby improving operating efficiency.

18. The wireless power receiver of claim 17 wherein the modulation scheme employed by the control circuitry further comprises:
incrementally increasing the modulation depth responsive to a plurality of communication failures; and
incrementally decreasing the modulation depth responsive to a plurality of absences of communication failures.

19. The wireless power receiver of claim 17 wherein the symbols communicated to the wireless power transmitter are encoded with a differential Manchester encoding scheme.

20. The wireless power receiver of claim 19 wherein increased modulation depths are selectively applied to symbols more susceptible to channel interference.

21. The wireless power receiver of claim 17 wherein the load modulation circuitry includes a controllable current source coupled to a DC side of the rectifier, and the higher modulation depth corresponds to a higher current drawn by the controllable current source.

22. The wireless power receiver of claim 17 wherein the load modulation circuitry includes one or more controllable capacitances connected to an AC side of the rectifier.

23. The wireless power receiver of claim 22 wherein the one or more controllable capacitances includes at least one communication capacitor selectively couplable to ground by a communication switch.

24. The wireless power receiver of claim 23 wherein the one or more controllable capacitances includes:
a capacitor bank including a first communication capacitor and one or more additional communication capacitors selectively couplable in parallel with the first communication capacitor by one or more switches corresponding to the one or more additional communication capacitors; and
a communication switch that selectively couples the first communication capacitors and any selectively paralleled communication capacitors to ground.

25. The wireless power receiver of claim 23 wherein the one or more controllable capacitances includes at least one communication capacitor selectively couplable to ground by one or more of a plurality of communication switches selectively operable in parallel.
